(19) United States
(12) Patent Application Publication
(10) Pub. No.: US 2025/0292562 A1
(43) Pub. Date: Sep. 18, 2025

(54) ADAPTABLE IMAGE SIGNAL PROCESSING FOR A VEHICLE

(71) Applicant: AUTOBRAINS TECHNOLOGIES LTD., Tel Aviv -Yafo (IL)

(72) Inventor: Igal Raichelgauz, Tel Aviv-Yafo (IL)

(73) Assignee: AUTOBRAINS TECHNOLOGIES LTD., Tel Aviv -Yafo (IL)

(21) Appl. No.: 18/606,772

(22) Filed: Mar. 15, 2024

(51) Int. Cl. G06V 10/94; G06T 1/20; G06V 20/56

(52) U.S. Cl. CPC G06V 10/955; G06T 1/20; G06V 20/56

(57) ABSTRACT

A method that is computer implemented and is for adaptable image signal processing for a vehicle, the method includes (i) receiving, by a processing circuit, environmental information about an environment of the vehicle; the environmental information being generated based in part on processing of images using a first image signal processing configuration; (ii) analyzing, by the processing circuit, the received environmental information to determine a scenario as represented by the environmental information; (iii) determining, by the processing circuit and based on the analyzing, a second image signal processing configuration that corresponds to the scenario; and (iv) providing a prompt indicative of a need to change the processing of incoming images captured along the determined scenario using the second image signal processing configuration.

### FIELD OF DISCLOSURE

The present disclosure relates to the field of computer technology, and more importantly, a method, non-transitory computer-readable storage medium, and a system for adaptable image signal processing for a vehicle.

### BACKGROUND

An autonomous vehicle includes a camera for sensing the environment of the autonomous vehicle and generating images which are processed in order to determine environment metadata that may impact the navigation of the autonomous vehicle.

The processing includes image signal processing and additional processing. The additional processing includes object detection and may include further processing.

It has been found that a processing of the images is susceptible to sub-optimal sensing and/or to changes in environmental conditions.

Therefore, there is a growing need to provide a robust sensing related solution.

The present disclosure provides a method, non-transitory computer-readable storage medium and computer-implemented system for training a neural network model as well as visualizing a latent representation of a neural network model.

In a first aspect of the present disclosure, A method of processing adaptable image signal for a vehicle is provided. The method includes receiving, by a processing circuit, environmental information about an environment of the vehicle, the environmental information being generated based in part on processing of images using a first image signal processing configuration; analyzing, by the processing circuit, the received environmental information to determine a scenario as represented by the environmental information; determining, by the processing circuit and based on the analyzing, a second image signal processing configuration that corresponds to the scenario; and providing a prompt indicative of a need to change the processing of incoming images captured along the determined scenario using the second image signal processing configuration.

In another aspect of the present disclosure, a non-transitory computer readable medium is provided. The non-transitory computer readable medium processes adaptable image signal that stores instruction that once executed by a processing circuit causes the processing circuit to receive, by a processing circuit, environmental information about an environment of the vehicle; the environmental information being generated based in part on processing of images using a first image signal processing configuration; analyze the received environmental information to determine a scenario as represented by the environmental information; determine, based on the analyzing, a second image signal processing configuration that corresponds to the scenario; and provide a prompt indicative of a need to change the processing of incoming images captured along the determined scenario using the second image signal processing configuration.

In another aspect of the present disclosure, a system for processing adaptable image signal for a vehicle is provided. The system includes a processing circuitry; and a memory, the memory containing instructions that, when executed by the processing circuitry, configure the system to: receive, by the processing circuitry, environmental information about an environment of the vehicle; the environmental information being generated based in part on processing of images using a first image signal processing configuration; analyze the received environmental information to determine a scenario as represented by the environmental information; determine, based on the analyzing, a second image signal processing configuration that corresponds to the scenario; and provide a prompt indicative of a need to change the processing of incoming images captured along the determined scenario using the second image signal processing configuration.

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a system, according to an embodiment of the present disclosure;

FIG. 2 illustrates an example of a system, according to an embodiment of the present disclosure;

FIG. 3 illustrates an example of an image signal processor, according to an embodiment of the present disclosure;

FIG. 4 illustrates an example of units and software components, according to an embodiment of the present disclosure;

FIG. 5 illustrates an example of a method, according to an embodiment of the present disclosure; and

FIG. 6 illustrates an example of a method, according to an embodiment of the present disclosure.

### DETAILED DESCRIPTION OF EXAMPLE EMBODIMENTS

The different figures illustrate examples of units and/or software and/or information items and/or steps and/or components. These examples are provided for brevity of explanation. At least one of the units and/or software and/or information items and/or steps and/or components is optional or mandatory.

According to an embodiment there is provided a method, system and a non-transitory computer readable medium that adapts image signal processing to a scenario that is reflected, at least in part, in environmental information about an environment of a vehicle. The system includes a sensing unit of the vehicle that senses images.

The images are processed using a first image signal processing configuration.

Also, a processing circuit receives environmental information about an environment of the vehicle.

Following a reception of the environmental information, the processing circuit analyzes the received environmental information to determine a scenario as represented by the environmental information. According to an embodiment, the scenario may be a singular location or a combination of properties at a point in time. According to another embodiment, the scenario may be a combination of one or more objects within the environment of the vehicle. According to yet another embodiment, the scenario may further include additional factors such as time and/or location.

Further non-limiting examples of scenarios may include entering a tunnel, exiting a tunnel, entering or exiting a curve, being bypassed by another vehicle, entering a school zone, entering a hazardous scenario, changing lighting conditions, and the like.

The processing circuit is further configured to determine, based on the analyzing, a second image signal processing configuration that corresponds to the scenario.

According to an embodiment, the processing circuit is configured to maintain the first image signal processing configuration. This may occur when the first image signal processing configuration is more suited to the current scenario and/or when the difference between the first image signal processing configuration and the second image signal processing configuration does not justify replacing the first image signal processing configuration by the second image signal processing configuration. The latter may occur when the difference between the performance associated with the replacement of the image signal processing configuration does not merit the cost of changing the image signal processing configuration.

According to an embodiment, a scenario may correspond with an image signal processing configuration that was found in any manner (based on estimates and/or simulation and/or machine learning and/or measurements).

According to an embodiment, the way in which image signal processing configuration corresponds to a scenario may indicate at least one of the following:
Any processing related to the image is better fit to the scenario.
Provides less false positive detection of objects.
Provides less false positive detection of objects.
Provide more true positive detections of objects.
Provides a more accurate object detection.
Provides a more accurate object classification.
Provides a more accurate driving decision.
Provide a more accurate allocation of resources.
Results in a more accurate selection of a narrow artificial intelligence agent out of multiple artificial intelligence agents.
Results in a sharper output image.
Results in a more accurate segmentation.
Increases the chances of detecting objects in the image.
Provides an image that improves the performance of any neural network and or any other machine learning process that follows the generation of the image.
Once applied, reduced the chances of an accident.
Once applied, reduced the chances of a near accident.
Once applied, consumes less memory and/or computational resources.

According to an embodiment, the determining of applying the second image signal processing parameter is further based on one or more additional factors or parameters.

An example of an additional factor or parameter is a parameter related to the vehicle. For example—the additional factor may be the status of elements of the sensing unit—which optics is operational, which sensing elements are faulty, and the like.

The sensing elements may differ by type—for example may be configured to sensed radiation of different spectrum and/or may belong to active or passive sensors. Examples of different spectrums include visual light spectrum, different colors, infrared, radar imagery, ultrasound, electro-optics, radiography, LIDAR (light detection and ranging), etc.

An example of an additional factor or parameter includes a performance indicator for an autonomous driving application. For example—an indicator that determines which automatic driving operation is safer, which autonomous driving is more resource consuming, and the like.

According to an embodiment, the second image signal processing configuration differs from the first image signal processing configuration, and the determining of the second image signal processing configuration is followed by responding to the determination.

According to an embodiment the responding includes at least one of:
Automatically triggering an activation of an image signal processor of the vehicle with the second image signal processing configuration during a processing of an image captured along the determined scenario of the vehicle.
Activating the image signal processor for using of the second image signal processing configuration.
Uploading second image signal processing configuration metadata defining the second image signal processing configuration from a remote memory unit.
Uploading second image signal processing configuration metadata defining the second image signal processing configuration from a local memory unit.
Selecting an image signal processing engine, out of a group of image signal processing engines, for use during the processing of the image captured along the determined scenario.
Deactivating an image signal processing engine.
Selecting an image signal processor, out of a group of image signal processors, for use during the processing of the image captured along the determined scenario.
Selecting a parameter of an image signal processing engine to be used during the processing of the image captured along the determined scenario.
Selecting a parameter of an image signal processor to be used during the processing of the image captured along the determined scenario.
Defining a hardware component of the image signal processor for use during the processing of the image captured along the determined scenario.
Defining a software component of the image signal processor to be used during the processing of the image captured along the determined scenario.

According to an embodiment, examples of image signal processing engine parameters are parameters of either one of the mentioned above elements.

According to an embodiment there is provided a method, system and a non-transitory computer readable medium that adapts and/or replaces and/or applies a sensing solution to environmental information about an environment of a vehicle.

According to an embodiment, the sensing solution adjusts and/or selects and/or impacts one or more optics and/or one or more sensing element groups and/or one or more read out circuits, and/or one or more image signal processors and/or one or more processing circuits and/or processes.

According to an embodiment, the sensing solution is selected based on one or more performance metrics that are determined at least in part based on environmental information.

Any reference to the image signal processing is applicable, mutatis mutandis, to the sensing unit solution.

According to an embodiment, a sensing system of the vehicle senses images. The images are processed using a first image signal processing configuration.

A processing circuit receives environmental information about an environment of the vehicle, and

analyzes the received environmental information to determine a performance metric related to, at least, the environmental information. Further, the processing circuit is configured to select, based on the performance metric, a sensing solution that conforms to the environmental information, and triggers an applying of the sensing solution by one or more sensing unit elements.

According to an embodiment, the processing metric is determined in any manner—simulation, tests, training machine learning processes, analyzing sensed information received from events tagged as accidents or near accidents that occurred due to sensing related errors (for example—unclear images, missing relevant information that caused an accident, different light conditions that resulted in detection errors, and the like).

According to an embodiment, the environmental information is generated using a second sensing solution that differs from the selected sensing solution.

According to an embodiment, the processing circuit is configured to determine to maintain the second sensing solution. This may occur when the first sensing solution is more suited to the current scenario and/or when the difference between the first sensing solution and the second sensing solution does not justify replacing the first sensing solution by the second image signal processing configuration. The latter may occur when the difference between the performance associated with the replacement of the sensing solution does not merit the cost of changing the image signal processing configuration.

According to an embodiment, the determined sensing solution, once applied, may result in:
less false positive detection of objects.
less false positive detection of objects.
more true positive detections of objects.
a more accurate object detection.
a more accurate object classification.
a more accurate driving decision.
a more accurate allocation of resources.
a more accurate selection of a narrow artificial intelligence agent out of multiple artificial intelligence agents.
a sharper output image.
a more accurate segmentation.
increased chances of detecting objects in the image.
an image that improves the performance of any neural network and or any other machine learning process that follows the generation of the image.
reduced the chances of an accident.
reduced the chances of a near accident.
less consumption of memory and/or computational resources.

According to an embodiment, the processing circuit is configured to respond to the determined sensing solution.

According to an embodiment, the response includes performing at least one of the following operations and/or triggering the performing of the at least one of the following operations:
Selecting an optics out of a plurality of optics.
Determining a parameter of one or more optics of the plurality of optics.
Selecting one or more sensing element groups of a plurality of sensing element groups.
Determining a parameter of one or more sensing element groups of the plurality of sensing element groups.
Selecting a readout circuit out of a plurality of readout circuits.
Determining a parameter of one or more readout circuits of the plurality of readout circuits.
Activating the image signal processor for the use of the second image signal processing configuration.
Uploading second image signal processing configuration metadata defining the second image signal processing configuration from a remote memory unit.
Uploading second image signal processing configuration metadata defining the second image signal processing configuration from a local memory unit.
Selecting an image signal processing engine, out of a group of image signal processing engines, for use during the processing of the image captured along the determined scenario.
Deactivating an image signal processing engine.
Selecting an image signal processor, out of a group of image signal processors, for use during the processing of the image captured along the determined scenario.
Selecting a parameter of an image signal processing engine to be used during the processing of the image captured along the determined scenario.
Selecting a parameter of an image signal processor to be used during the processing of the image captured along the determined scenario.
Defining a hardware component of the image signal processor for use during the processing of the image captured along the determined scenario.
Defining a software component of the image signal processor to be used during the processing of the image captured along the determined scenario.
Selecting an object detection software of a plurality of object detection software.
Selecting a parameter of an object detection software of a plurality of object detection software.
Selecting an scenario detection software of a plurality of scenario detection software.
Selecting a parameter of a scenario detection software of a plurality of scenario detection software.
Selecting a post object detection software of a plurality of post object detection software.
Selecting a parameter of a post object detection software of a plurality of post object detection software.
Selecting a post scenario detection software of a plurality of post scenario detection software.
Selecting a parameter of a post scenario detection software of a plurality of post scenario detection software.
Selecting a machine learning process of a plurality of machine learning processes.
Selecting a machine learning process parameter of a machine learning process of a plurality of machine learning processes.
Selecting a sensor fusion solution out of multiple sensor fusion solutions.
Selecting a parameter of a sensor fusion solution.

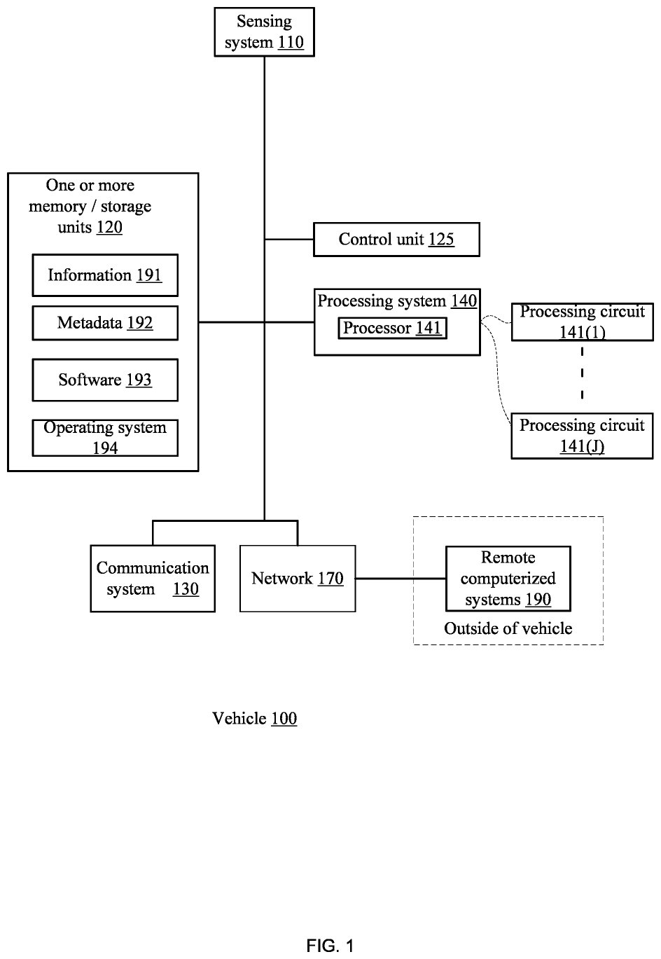

FIG. 1 illustrates an example of a computerized system of a vehicle 100 and its surroundings, according to an embodiment of the disclosure. The vehicle 100 includes a sensing system 110, one or more memory and/or storage units 120, a communication system 130, a control unit 125, and processing system 140 including a processor 141 that includes processing circuits 141(1)-141(J).

FIG. 1 also illustrates a network 170 and one or more remote computerized systems 190 such as servers, cloud computers, and the like. The control unit 125 is configured to control various operations related to the vehicle—such as but not limited to various steps of method 400 and/or of method 500.

The one or more memory and/or storage units 120 are illustrated as storing an operating system 194, software 193 (especially software required to execute method 400 and/or of method 500), information 191 and metadata 192 (especially information and metadata required to execute method 400 and/or of method 500). The information may include environmental information. The metadata may include any metric or an outcome of processed information—especially related to the execution of method 400 and/or of method 500.

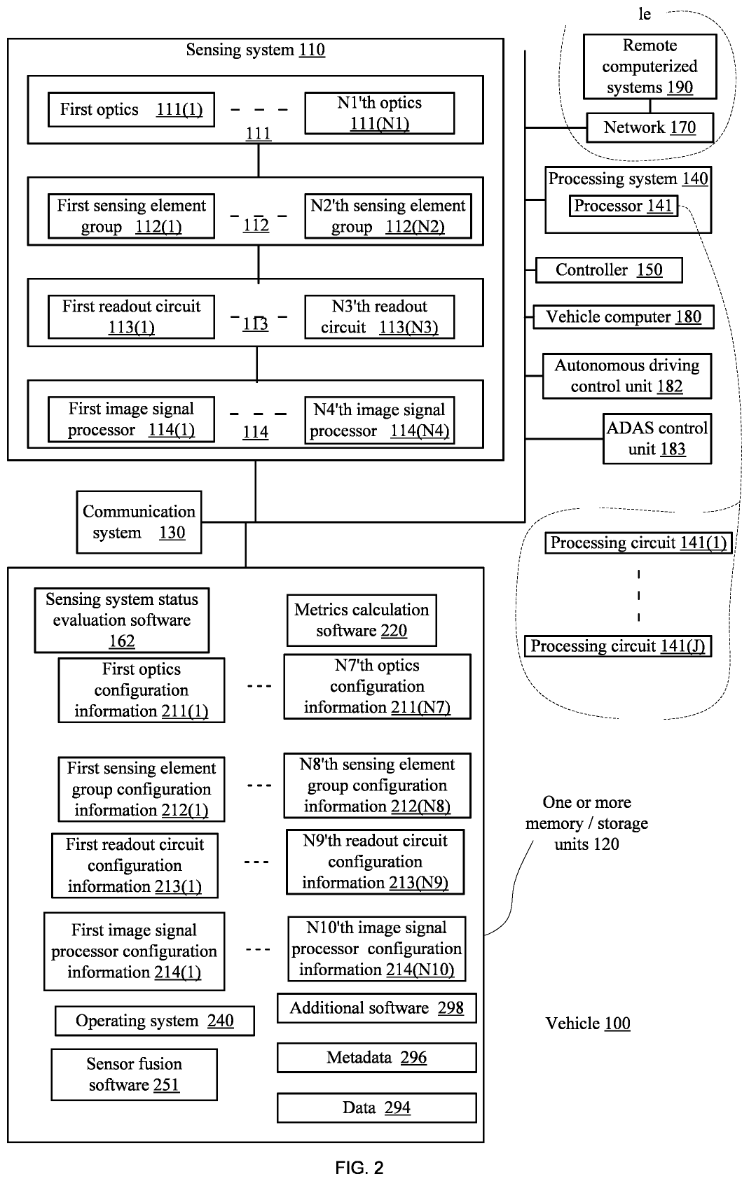

FIG. 2 illustrates an example of a sensing system 110, a communication system 130, one or more memory and/or storage units 120, and additional units that include ADAS control unit 183, autonomous driving control unit 182, vehicle computer 180, controller 150, processing system 140 including processor 141—all included in a vehicle. FIG. 2 also illustrates a network 170 and one or more remote computerized systems 190 such as servers, cloud computers, and the like.

Sensing system 110 includes (a) a first plurality of optics 111(1)-111(N1) (collectively denoted 111), (b) a second plurality of sensing element groups 112(1)-112(N2) (collectively denoted 112), (c) a third plurality of readout circuits 113(1)-113(N3) (collectively denoted 113), and (d) a fourth plurality of image signal processors 114(1)-114(N4) (collectively denoted 114).

According to an embodiment, a sensing solution includes selecting one of more of the plurality of optics, one or more of the sensing element groups, one or more of the readout circuits, one or more of the image signal processor. This selection also includes selecting the connectivity and/or communication between the selected entities.

The communication system 130 is configured to enable communication between the one or more memory and/or storage units 120 and/or the sensing system 110 and/or any one of the additional units and/or the network 170 (that is in communication with the remote computerized systems).

The controller 150 is configured to control the operation of the sensing system 110, and/or the one or more memory and/or storage units 120 and/or the one or more additional units (except the controller).

The ADAS control unit 183 is configured to control ADAS operations.

The autonomous driving control unit 182 is configured to control autonomous driving of the autonomous vehicle.

The vehicle computer 180 is configured to control the operation of the vehicle-especially to control the engine, the transmission, and any other vehicle system or component.

The processing system 140 may include processor 141 and one or more other processors and is configured to execute any method illustrated in the specification.

The one or more memory and/or storage units 120 are configured to store firmware and/or software, one or more operating systems, data and metadata required to the execution of any of the methods mentioned in this application.

FIG. 2 illustrates the one or more memory and/or storage units 120 as storing at least one of:
Sensing system status evaluation software 162 for evaluating the status of the different elements of the sensing system (for example faulty, partially operational fully operational).
Metrics calculation software 220 for calculating any metric required for selecting a sensing solution.
The first optics configuration information 211(1) till the N7'th optics configuration information. For example—focal length, polarization, spectrum, spatial relationship between optical components, selection of optical components.
The first sensing element group configuration information 212(1) till the N8'th sensing element group configuration information. For example—dynamic range, signal to noise ratio, sensitivity, sensed wavelengths, selection of sensing elements groups, such as a linear array of pixel, a two dimensional array of pixels, and the like.
The first readout circuit configuration information 213(1) till the N9'th readout circuit configuration information 213(9). For example—sensitivity of readout circuit, selection of readout circuit, readout circuit reading duration, readout protocol, and the like.
The first image signal processor configuration information 214(1) till the N10'th image signal processor configuration information 214(N10).
Operating system 240.
Metadata 296.
Data 294.
Sensor fusion software 251.
Additional software 298.

The vehicle computer 180 may be in communication with an engine control module, a transmission control module, a powertrain control module, and the like

The memory and/or storage units 120 was shown as storing software. Any reference to software should be applied mutatis mutandis to code and/or firmware and/or instructions and/or commands, and the like.

Processor 141 includes a plurality of processing units 141(1)-141(J), J is an integer that exceeds one. Any reference to one unit or item should be applied mutatis mutandis to multiple units or items. For example—any reference to processor should be applied mutatis mutandis to multiple processors, any reference to a communication system should be applied mutatis mutandis to multiple communication systems.

According to an embodiment, the one or more memory and/or storage units 120 includes one or more memory unit, each memory unit may include one or more memory banks.

According to an embodiment, the one or more memory and/or storage units 120 includes a volatile memory and/or a non-volatile memory. The one or more memory and/or storage units 120 may be a Random Access Memory (RAM) and/or a Read Only Memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, RAM, or ROM, Electrically Erasable Programmable Read-Only Memory (EEPROM), and the like.

Any content may be stored in any part or any type of the memory unit.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. FIG. 1 illustrates communication system 130. Other communication elements may be provided.

FIG. 2 illustrates communication system 130 as being in communication with various processors and/or units and network 17.

The communication system 130 may include a bus. The represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

FIG. 2 also illustrates network 170 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a Local Area Network (LAN) and a general Wide Area Network (WAN). Such network connections can be through a network adapter (may belong to communication system 130) which can be implemented in both wired and wireless environments. Such networking environments are conventional and commonplace in offices, enterprise-wide computer networks, intranets, and a network such as the internet.

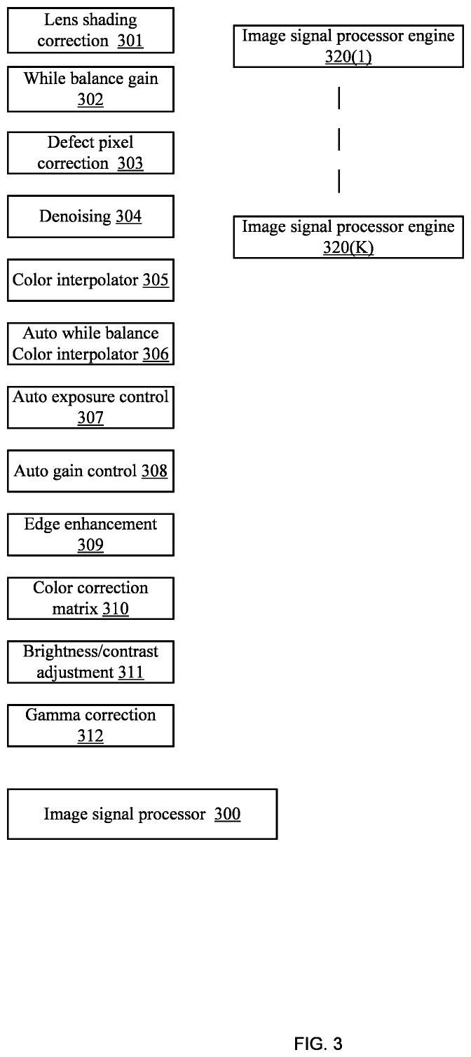

FIG. 3 illustrates image signal processing engine 300, a plurality (K) of image signal processor engines 320(1)-320(K).

According to an embodiment, an image signal processing engine includes at least one of the following, or any combination of sub-combination of any one of the following elements (all illustrated in FIG. 3):
Lens shading correction 301 that is configured to correct for brightness and color non-uniformity towards the image periphery.
Automatic white balance 302 that is configured to correct for the color temperature of the ambient lighting conditions, to preserve color constancy.
Defect pixel correction 303 that is configured to compensate for defective pixels of a sensing element group.
Denoising 304 that is configured to reduce the appearance of noise in the image.
Color interpolator 305 that is configured to convert a sensor's raw color data.
Auto while balance color interpolator 306 that is configured to correct for defective pixels on the image sensor.
Auto exposure control 307 that is configured to control the exposure of the sensing elements.
Auto gain control 308 that is configured to control the gain of the sensing unit.
Edge enhancement 309 that is configured to process a block which enhances edges, normally to make an image appear sharper to a human observer—while introducing artifacts.
Color correction matrix 310 that is configured to correct for cross-talk between adjacent sensor pixels.
Brightness/contrast adjustment 311 that is configured to enhance image contrast and digitally adjust image brightness.
Gamma correction 312 that is configured to adjust the contrast associated with different light levels differently, to increase the salience of features.

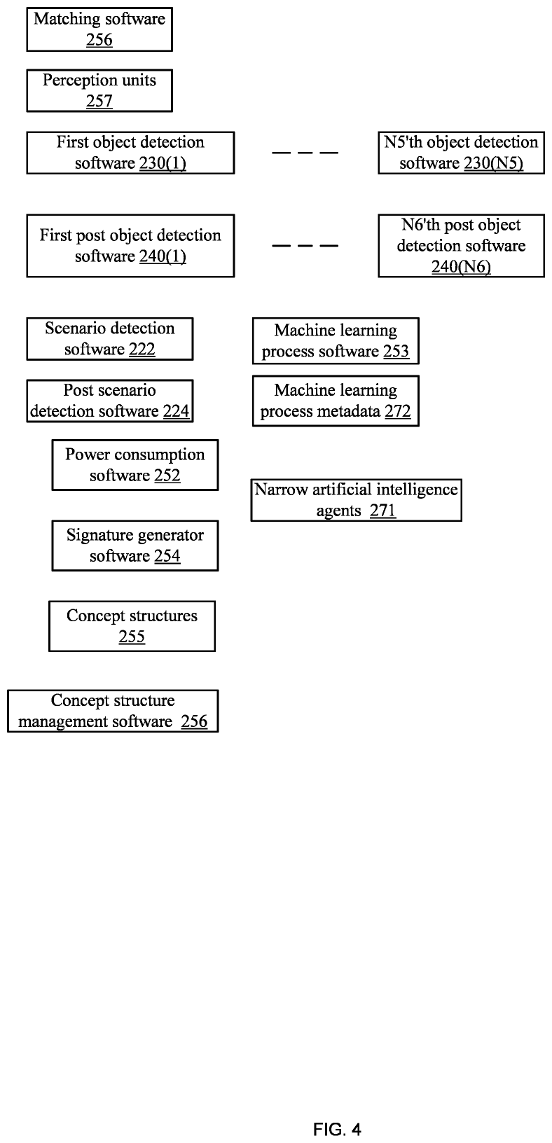

FIG. 4 illustrates example of additional software that can be stored in the one or more memory and/or storage units 120 and includes:
Scenario detection software 222 configured to detect a scenario captured by the environmental information.
Post scenario detection software 224 configured to respond to the detection of a scenario—for example performing scenario-based processing, selecting a sensing solution, selecting an image signal processing configuration, and the like.
A fifth plurality of object detection software—from the first object detection software 230(1) till the N5'th object detection software 230(N5). An object detection software may be regarded as a part of a sensing solution and the selection of the sensing solution may include selecting one of the object detection software.
A sixth plurality of post object detection software—from the first post object detection software 240(1) till the N6'th post object detection software 240(N6). A post object detection software may be regarded as a part of a sensing solution and the selection of the sensing solution may include selecting one of the post object detection software. Examples of post object detection software include determining driving related operations (including an ADAS operation and/or an autonomous driving related operation), executing of driving related operations, managing data structures, tuning one or more machine learning processes, and the like.
Signature generator software 254 for generating signatures of images, matching software 256 for matching the generated signatures to reference signatures (such as signatures that represents clusters or groups of concept structures 255), concept structure management software configured to manage the concept structures.
Power consumption software 252 configured to monitor power consumption of various units and/or components.
Perception units 257 configured to provide (at least) environmental information of one or more dimensions.
Narrow artificial intelligence agents 271 configured to generate driving related decision.
Machine learning process software 253 and machine learning metadata 272 for applying a machine learning process—as a part of a sensing solution and/or as a part of any processing and/or object detection, and the like.

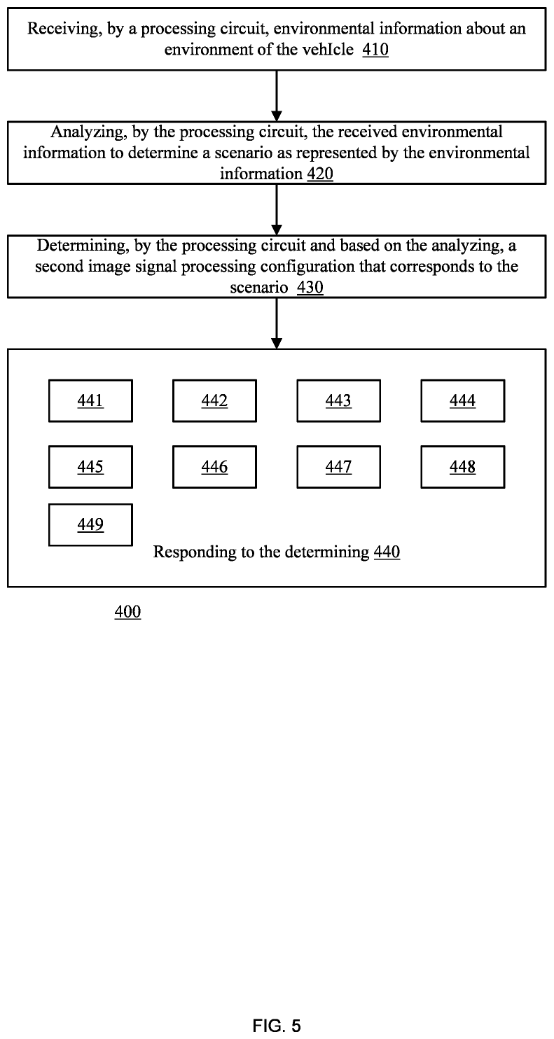

FIG. 5 illustrates an example of method 400.

According to an embodiment, method 400 is computer implemented and is for adaptable image signal processing for a vehicle.

According to an embodiment, method 400 includes step 410 of receiving, by a processing circuit, environmental information about an environment of the vehicle; the environmental information being generated based in part on processing of images using a first image signal processing configuration.

According to an embodiment, the environmental information is being generated by multiple perception modules.

According to an embodiment, step 410 is followed by step 420 of analyzing, by the processing circuit, the received environmental information to determine a scenario as represented by the environmental information.

According to an embodiment, step 420 is followed by step 430 of determining, by the processing circuit and based on the analyzing, a second image signal processing configuration that corresponds to the scenario.

The second image signal processing configuration may be stored in the vehicle or stored outside the vehicle.

According to an embodiment, the determining is based in part on a parameter related to the vehicle.

According to an embodiment, the determining is based in part on a performance indicator for an automated driving application.

According to an embodiment, step 430 is followed by step 440 of responding to the determining.

According to an embodiment, step 440 includes at least one of:
Step 441 of providing a prompt indicative of a need to change the processing of incoming images captured along the determined road scenario using the second image signal processing configuration. According to an embodiment, the providing of the prompt involves automatically triggering an activation of an image signal process with the second image signal processing configuration during the processing of the incoming images
Step 442 of automatically triggering an activation of an image signal process with the second image signal processing configuration during a processing of an image captured along the determined scenario of the vehicle.
Step 443 of activating the image signal process for the use of the second image signal processing configuration.
Step 444 of uploading second image signal processing configuration metadata defining the second image signal processing configuration from a remote memory unit.
Step 445 of selecting an image signal processing engine, out of a group of image signal processing engines, for use during the processing of the image captured along the determined scenario.
Step 446 of selecting a parameter of an image signal processing engine to be used during the processing of the image captured along the determined scenario.
Step 447 of selecting an image signal processor out of multiple image signal processors.
Step 448 of defining a hardware component of the image signal processor for use during the processing of the image captured along the determined scenario.
Step 449 of defining a software component of the image signal processor for use during the processing of the image captured along the determined scenario.

According to an embodiment, step 440 includes uploading a second image signal processing configuration metadata defining the second image signal processing configuration from a remote memory unit located outside the vehicle.

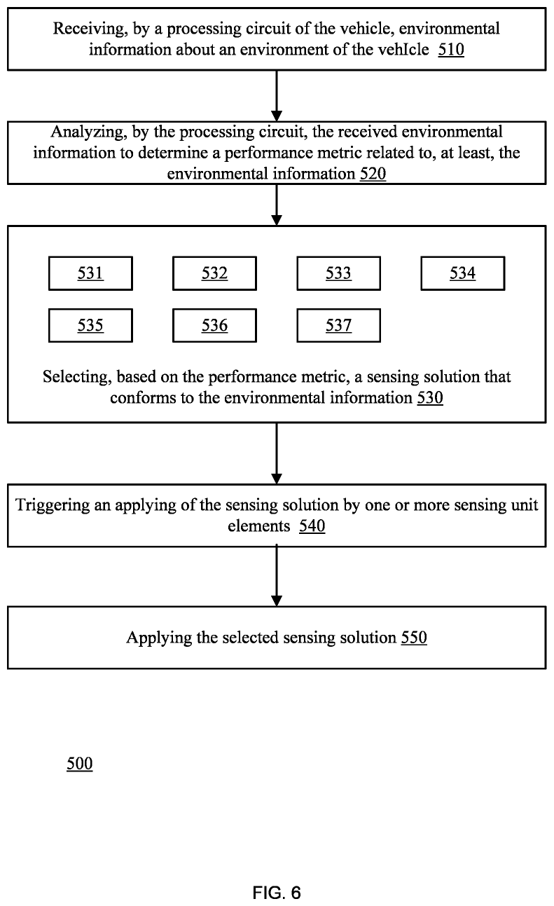

FIG. 6 illustrates an example of method 500.

According to an embodiment, method 500 is computer implemented and is for on demand management and control of image sensing for autonomous driving applications.

According to an embodiment, method 500 includes step 510 of receiving, by a processing circuit, environmental information about an environment of the vehicle.

According to an embodiment, step 510 is followed by step 520 of analyzing, by the processing circuit, the received environmental information to determine a performance metric related to, at least, the environmental information.

According to an embodiment, step 520 is followed by step 530 of selecting, based on the performance metric, a sensing solution that conforms to the environmental information.

According to an embodiment, step 530 includes at least one of:
Step 531 of selecting sensing element groups of different types.
Step 532 of selecting sensing element groups out of a plurality of sensing elements groups and selecting a sensor fusion solution for fusing detection signals out of a plurality of sensor fusion solutions.
Step 533 of selecting the sensing solution based on a status of sensing unit elements.
Step 534 of selecting an image sensing element groups of different types.
Step 535 of selecting an image signal processing configuration of multiple image signal processing configurations and selecting a combination of optics, sensing element group and readout circuit.
Step 536 of selecting any combination of optics, sensing element group, readout circuit, and image sensing processor.
Step 537 of selecting any value of any parameter of optics, sensing element group, readout circuit, and image sensing processor.

According to an embodiment, step 530 is followed by step 540 of triggering an applying of the sensing solution by one or more sensing unit elements.

According to an embodiment, the environmental information is generated using a second sensing solution that differs from the selected sensing solution.

According to an embodiment, step 530 is followed by step 550 of applying of the selected sensing solution.

According to an embodiment, there is provided a method that is computer implemented and is for on demand management and control of image sensing for autonomous driving applications. According to an embodiment, the method includes (i) receiving, by a processing circuit of the vehicle, environmental information about an environment of the vehicle; (ii) analyzing, by the processing circuit, the received environmental information to determine a quality parameter related to a quality of the environmental information; (iii) selecting, based on the quality parameter, a sensing solution that conforms to the environmental information; the environmental information; and (iv) applying the selected sensing solution in conjunction with images captured in the environment of the vehicle using a sensing unit element in compliance with the selected sensing solution, where the determined sensing solution is applied conditional on the analyzing of incoming environmental information conforming to the determined sensing solution.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the perception unit, narrow AI agents, driving decision unit may be implemented in hardware and/or code, instructions and/or commands stored in a non-transitory computer readable medium, may be included in a vehicle, outside a vehicle, in a mobile device, in a server, and the like. In some cases, there is a reference to software and in some cases there is a reference to units. A unit that includes a hardware component such as a processing circuit or a processor is configured to execute software. A software executable by a hardware component is regarded as a unit or a part of the unit.

The specification and/or drawings may refer to a concept structure. A concept structure may include one or more clusters. Each cluster may include signatures and related metadata. Each reference to one or more clusters may be applicable to a reference to a concept structure. Any reference to a cluster is applicable mutatis mutandis to a group.

The specification and/or drawings may refer to a processor. The processor may be a processing circuitry. The processing circuitry may be implemented as a Central Processing Unit (CPU), and/or one or more other integrated circuits such as Application-Specific Integrated Circuits (ASICs), Field Programmable Gate Arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “reassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

Further Embodiments are listed below.

Embodiment 1. A method of processing adaptable image signal for a vehicle, the method including: receiving, by a processing circuit, environmental information about an environment of the vehicle; the environmental information being generated based in part on processing of images using a first image signal processing configuration; analyzing, by the processing circuit, the received environmental information to determine a scenario as represented by the environmental information; determining, by the processing circuit and based on the analyzing, a second image signal processing configuration that corresponds to the scenario; and providing a prompt indicative of a need to change the processing of incoming images captured along the determined scenario using the second image signal processing configuration.

Embodiment 2. The method according to Embodiment 1, where the providing of the prompt involves automatically triggering an activation of an image signal process with the second image signal processing configuration during the processing of the incoming images.

Embodiment 3. The method according to Embodiments 1-2, further including activating the image signal process with the second image signal processing configuration.

Embodiment 4. The method according to Embodiments 1-3, wherein activating the image signal process with the second image signal processing configuration involves selecting an image signal processing engine, out of a group of image signal processing engines, for use during the processing of the image captured along the determined scenario.

Embodiment 5. The method according to Embodiments 1-4, wherein activating the image signal process with the second image signal processing configuration involves selecting a parameter of an image signal processing engine to be used during the processing of the image captured along the determined scenario.

Embodiment 6. The method according to Embodiments 1-5, wherein the determining of the second image signal processing configuration is also based on a parameter related to the vehicle.

Embodiment 7. The method according to Embodiments 1-6, wherein the determining of the second image signal processing configuration is also based on a performance indicator for an automated driving application.

Embodiment 8. A non-transitory computer readable medium for processing adaptable image signal that stores instruction that once executed by a processing circuit causes the processing circuit to: receive, by a processing circuit, environmental information about an environment of the vehicle; the environmental information being generated based in part on processing of images using a first image signal processing configuration; analyze the received environmental information to determine a scenario as represented by the environmental information; determine, based on the analyzing, a second image signal processing configuration that corresponds to the scenario; and provide a prompt indicative of a need to change the processing of incoming images captured along the determined scenario using the second image signal processing configuration.

Embodiment 9. The non-transitory computer readable medium according to Embodiment 8, where the providing of the prompt involves automatically triggering an activation of an image signal process with the second image signal processing configuration during the processing of the incoming images.

Embodiment 10. The non-transitory computer readable medium according to Embodiments 8 and 9, further including storing instructions for uploading second image signal processing configuration metadata defining the second image signal processing configuration from a remote memory unit.

Embodiment 11. A system for processing adaptable image signal for a vehicle, including a processing circuitry; and a memory, the memory containing instructions that, when executed by the processing circuitry, configure the system to: receive, by the processing circuitry, environmental information about an environment of the vehicle; the environmental information being generated based in part on processing of images using a first image signal processing configuration; analyze the received environmental information to determine a scenario as represented by the environmental information; determine, based on the analyzing, a second image signal processing configuration that corresponds to the scenario; and provide a prompt indicative of a need to change the processing of incoming images captured along the determined scenario using the second image signal processing configuration.

Embodiment 12. The system according to Embodiment 11, where the providing of the prompt involves automatically triggering an activation of an image signal process with the second image signal processing configuration during the processing of the incoming images.

Embodiment 13. The system according to Embodiments 11 and 12, wherein the system is further configured to activate the image signal process with the second image signal processing configuration.

Embodiment 14. The system according to Embodiments 11-13, wherein activating the image signal process with the second image signal processing configuration involves selecting an image signal processing engine, out of a group of image signal processing engines, for use during the processing of the image captured along the determined scenario.

Embodiment 15. The system according to Embodiments 11-14, wherein activating the image signal process with the second image signal processing configuration involves selecting a parameter of an image signal processing engine to be used during the processing of the image captured along the determined scenario.

Embodiment 16. The system according to Embodiments 11-15, wherein the determining of the second image signal processing configuration is also based on a parameter related to the vehicle.

Embodiment 17. The system according to Embodiments 11-16, wherein the determining of the second image signal processing configuration is also based on a performance indicator for an automated driving application.

We claim:

1. A method of processing adaptable image signal for a vehicle, the method comprising:
receiving, by a processing circuit, environmental information about an environment of the vehicle; the environmental information being generated based in part on processing of images using a first image signal processing configuration;
analyzing, by the processing circuit, the received environmental information to determine a scenario as represented by the environmental information;
determining, by the processing circuit and based on the analyzing, a second image signal processing configuration that corresponds to the scenario; and
providing a prompt indicative of a need to change the processing of incoming images captured along the determined scenario using the second image signal processing configuration.

2. The method according to claim 1, where the providing of the prompt involves automatically triggering an activation of an image signal process with the second image signal processing configuration during the processing of the incoming images.

3. The method according to claim 1, further comprising activating the image signal process with the second image signal processing configuration.

4. The method according to claim 3, wherein activating the image signal process with the second image signal processing configuration involves selecting an image signal processing engine, out of a group of image signal processing engines, for use during the processing of the image captured along the determined scenario.

5. The method according to claim 3, wherein activating the image signal process with the second image signal processing configuration involves selecting a parameter of an image signal processing engine to be used during the processing of the image captured along the determined scenario.

6. The method according to claim 1, wherein the determining of the second image signal processing configuration is also based on a parameter related to the vehicle.

7. The method according to claim 1, wherein the determining of the second image signal processing configuration is also based on a performance indicator for an automated driving application.

8. A non-transitory computer readable medium for processing adaptable image signal that stores instruction that once executed by a processing circuit causes the processing circuit to:
receive, by a processing circuit, environmental information about an environment of the vehicle; the environmental information being generated based in part on processing of images using a first image signal processing configuration;
analyze the received environmental information to determine a scenario as represented by the environmental information;
determine, based on the analyzing, a second image signal processing configuration that corresponds to the scenario; and
provide a prompt indicative of a need to change the processing of incoming images captured along the determined scenario using the second image signal processing configuration.

9. The non-transitory computer readable medium according to claim 8, where the providing of the prompt involves automatically triggering an activation of an image signal process with the second image signal processing configuration during the processing of the incoming images.

10. The non-transitory computer readable medium according to claim 8, further comprising storing instructions for uploading second image signal processing configuration metadata defining the second image signal processing configuration from a remote memory unit.

11. A system for processing adaptable image signal for a vehicle, comprising
a processing circuitry; and
a memory, the memory containing instructions that, when executed by the processing circuitry, configure the system to:
receive, by the processing circuitry, environmental information about an environment of the vehicle; the environmental information being generated based in part on processing of images using a first image signal processing configuration;
analyze the received environmental information to determine a scenario as represented by the environmental information;
determine, based on the analyzing, a second image signal processing configuration that corresponds to the scenario; and
provide a prompt indicative of a need to change the processing of incoming images captured along the determined scenario using the second image signal processing configuration.

12. The system according to claim 11, where the providing of the prompt involves automatically triggering an activation of an image signal process with the second image signal processing configuration during the processing of the incoming images.

13. The system according to claim 11, wherein the system is further configured to activate the image signal process with the second image signal processing configuration.

14. The system according to claim 13, wherein activating the image signal process with the second image signal processing configuration involves selecting an image signal processing engine, out of a group of image signal processing engines, for use during the processing of the image captured along the determined scenario.

15. The system according to claim 11, wherein activating the image signal process with the second image signal processing configuration involves selecting a parameter of an image signal processing engine to be used during the processing of the image captured along the determined scenario.

16. The system according to claim 11, wherein the determining of the second image signal processing configuration is also based on a parameter related to the vehicle.

17. The system according to claim 11, wherein the determining of the second image signal processing configuration is also based on a performance indicator for an automated driving application.
